(19) United States
(12) Patent Application Publication
(10) Pub. No.: US 2002/0149817 A1
(43) Pub. Date: Oct. 17, 2002

(54) Open ring architectures for optical WDM networks

(76) Inventors: Han Kiliccote, Sunnyvale, CA (US); Cuneyt Ozveren, Saratoga, CA (US); Mark Lowry, Castro valley, CA (US)

Correspondence Address: WILSON SONSINI GOODRICH & ROSATI, 650 PAGE MILL ROAD, PALO ALTO, CA, 943041050

(21) Appl. No.: 10/113,777

(22) Filed: Mar. 29, 2002

Related U.S. Application Data
(60) Provisional application No. 60/280,347, filed on Mar. 29, 2001.
(60) Provisional application No. 60/280,550, filed on Mar. 29, 2001.

(51) Int. Cl. H04B 10/20; H04J 14/00; H04J 14/02

(52) U.S. Cl. 359/119; 359/127

(57) ABSTRACT

Methods and apparatuses of open ring optical networks are disclosed, as well as optical nodes, for example open intercepts and closed intercepts, supporting open ring optical networks. Open ring optical networks can prevent optical wavelengths from traversing an optical node in an optically transparent network. Optical feedback can be prevented in open ring optical networks, for example optical networks containing optical amplifiers. Coherent crosstalk can be prevented in open ring optical networks. Some open ring networks further allow standard communication protection techniques that are typically associated with rings which are topologically closed. These network architectures can enable low cost-of-maintenance bandwidth upgrades to the entire network.

### CROSS REFERENCE TO RELATED APPLICATIONS

This application claims the benefit of the U.S. Provisional Patent Application No. 60/280,347 filed Mar. 29, 2001, which is incorporated by reference herein its entirety. Additionally this application is related to co-pending U.S. patent application No. ______, filed Mar. 29, 2002, concurrently herewith entitled “Methods and Apparatus for Reconfigurable WDM Lightpath Rings” claiming the benefit of the U.S. Provisional Patent Application No. 60/280,550, filed Mar. 29, 2001 which are incorporated by reference herein in their entirety.

### BACKGROUND OF INVENTION

1. Field of Invention

The invention relates generally to optical networking, and more particularly, to metro area optical networks.

2. Description of Related Art

Reconfigurable WDM networks will require the ability to change the optical path of connections, which includes changing the optical length. Optical length can include the length of fiber and the number of nodes passed through. Optical length can be proportional to optical loss. The larger the network, the larger the range of optical losses to be accommodated. Scaling this kind of network requires optical amplifiers to make the network “transparent”, which effectively decouples the length from the loss, for example with optical amplifiers to make up for the losses.

One of the simplest and most robust kinds of network employs a ring topology at the physical layer. Rings are one logical choice for reconfigurable WDM networks. However, in a closed ring, optical signals are free to propagate completely around the ring, over and over. Closed rings mean a closed optical path, or a path in which photons have a route which they repeatedly traverse in some type of a “loop”. Closed rings lead to several types of transmission impairments. Difficulties arise in the presence of optical amplification.

The amplified spontaneous emission (ASE) from the optical gain media undergoes feedback via the closed ring into the gain media. This leads to several phenomena that place very severe constraints on the system.

First, the net gain of the system has a firm limit of 1 (0 dB or effectively no loss), the threshold for lasing to occur in the ring. Attempting to increase gain beyond this only increases the power in the lasing line that develops. The closed optical loop effectively becomes a ring laser. This lasing can be extremely unstable leading to further sources of transmission impairment. WDM signals may not increase in power.

Second, if the net gain approaches very close (within a few dB) of the lasing condition (net gain of 1) the ASE noise floor increases dramatically. This noise creates severe WDM signal degradation. In the presence of optical amplification, the accumulation of ASE noise is a significant impairment. Effectively, closing the loop is equivalent to a large, or infinite, number of amplifiers in series. This increased ASE, leads to significant signal impairment through the mechanism of ASE-signal, and ASE-ASE mixing. This impairment is greatly enhanced in the presence of a closed optical loop.

These effects serve to greatly limit the available dynamic range for connections within the network. This is compounded by the fact that optical amplifiers can have non-uniform gain as a function of wavelength. The result is that the closed ring with amplification does not scale to a very large number of wavelengths and/or nodes.

With many present optical networks, the above constraints are less problematic or a nonissue, because many present optical networks lack optical transparency to some degree. Nontransparent networks, for example a 2.5 Gb/s SONET network, require one or more optical-to-electrical-to-optical conversions of signals, even when the signals are merely transiting an intermediate network node along the way from a source node to a destination node.

Closed rings with optical transparency also encounter coherent crosstalk and gain transients.

The impairment of coherent crosstalk arises when a particular wavelength is intended to be completely dropped at an optical add drop multiplexer (OADM) in a network, but is incompletely dropped instead. Incomplete dropping of a wavelength is not unusual, insofar as wavelength drop elements can be imperfect. If the signal at the wavelength that was incompletely dropped is allowed to return to the site of the signal's intended drop, through the “loop” of a closed ring, a delayed version of the signal interferes with the original signal, producing the impairment of coherent crosstalk. This can easily lead to a significant signal power penalty. This can become especially severe if the closed loop is nearly completely transparent, as could be the case in many practical implementations that incorporate optical amplification. One solution to coherent crosstalk minimizes the impairment of coherent crosstalk in the presence of closed rings, but relies exclusively on extremely high-performance wavelength drop elements, which can be very expensive.

Wavelength reconfiguration of the type used in the optical networks can lead to abrupt changes in the optical signal which is input to the optical amplifiers in the system. This leads to transients in the gain of these amplifiers. These transients can be significantly enhanced or amplified, with amplifiers placed in series. When these enhanced transients feedback on themselves in a closed ring, the instabilities in gain can be further exacerbated, for example through control instability phenomena known as limit-cycles.

### SUMMARY OF INVENTION

Some embodiments of the invention take advantage of an open ring architecture for on optically transparent optical network. The open ring architecture can prevent an optical signal from topologically looping and thereby prevent the optical signal from returning to the origin of the optical signal.

Some embodiments of an optical network include at least two optical fiber segments, one or more optical nodes, and one or more decoupling nodes. The first optical fiber segment has a first end and a second end. The second optical fiber segment has a first end and a second end. The one or more optical nodes are coupled to the second end of the first optical fiber segment and the second end of the second optical fiber segment. The one or more optical decoupling nodes are coupled to the first end of the first optical fiber segment and the first end of the second optical fiber segment. The one or more optical nodes include one or more optically transparent nodes optically transparent in at least one direction for one or more optical wavelengths at least optically traversing the one or more optically transparent nodes. One or more optical wavelengths carry traffic of the optical network. The one or more optical decoupling nodes substantially prevent at least one of the one or more optical wavelengths from at least optically traversing the one or more optical decoupling nodes.

Some embodiments of an optical network include at least two optical fiber segments, one or more optical nodes, and one or more optical anti-feedback nodes. The first optical fiber segment has a first end and a second end. The second optical fiber segment has a first end and a second end. The one or more optical nodes are coupled to the second end of the first optical fiber segment and the second end of the second optical fiber segment. The one or more optical anti-feedback nodes are coupled to the first end of the first optical fiber segment and the first end of the second optical fiber segment. The one or more optical anti-feedback nodes substantially prevent optical feedback in the optical network. The one or more optical nodes include one or more optically transparent nodes optically transparent in at least one direction for one or more optical wavelengths at least optically traversing the one or more optically transparent nodes.

Some embodiments of an optical network include at least two optical fiber segments, one or more optical nodes, and one or more optical anti-crosstalk nodes. The first optical fiber segment has a first end and a second end. The second optical fiber segment has a first end and a second end. The one or more optical nodes are coupled to the second end of the first optical fiber segment and the second end of the second optical fiber segment. The one or more optical anti-crosstalk nodes are coupled to the first end of the first optical fiber segment and the first end of the second optical fiber segment. The one or more optical anti-crosstalk nodes substantially prevent coherent crosstalk in the optical network. The one or more optical nodes include one or more nodes optically transparent in at least one direction.

Some embodiments of an optical node include one or more housings. The one or more housings at least substantially enclose a wavelength add, a wavelength drop, and at least two optical ports. The first optical port is adapted to at least optically couple to a first node of one or more optical nodes. The first optical port is at least optically coupled to the wavelength add. The second optical port is adapted to at least optically couple to a second node of the one or more optical nodes. The second optical port is at least optically coupled to the wavelength drop. The one or more optical nodes include one or more optically transparent nodes optically transparent in at least one direction for one or more optical wavelengths at least optically traversing the one or more optically transparent nodes. The first optical port and the second optical port remain at least optically substantially decoupled within the optical node at one or more optical wavelengths that carry traffic in at least part of the one or more optical nodes.

Some embodiments of an optical node include one or more housings. The one or more housings at least substantially enclose a wavelength add, a wavelength drop, and at least two optical ports. The first optical port is adapted to at least optically couple to a first node of one or more optical nodes. The first optical port is at least optically coupled to the wavelength add. The second optical port is adapted to at least optically couple to a second node of the one or more optical nodes. The second optical port is at least optically coupled to the wavelength drop. The one or more optical nodes include one or more optically transparent nodes optically transparent in at least one direction for one or more optical wavelengths at least optically traversing the one or more optically transparent nodes. The optical node substantially prevents optical feedback in the one or more optical nodes.

Some embodiments of an optical node include one or more housings. The one or more housings at least substantially enclose a wavelength add, a wavelength drop, and at least two optical ports. The first optical port is adapted to at least optically couple to a first node of one or more optical nodes. The first optical port is at least optically coupled to the wavelength add. The second optical port is adapted to at least optically couple to a second node of the one or more optical nodes. The second optical port is at least optically coupled to the wavelength drop. The one or more optical nodes include one or more optically transparent nodes optically transparent in at least one direction for one or more optical wavelengths at least optically traversing the one or more optically transparent nodes. The optical node substantially prevents coherent crosstalk in the one or more optical nodes.

Some embodiments are methods of optical networking. A first group of one or more optical signals is added to an optical ring carrying wavelength division multiplexed signals. A second group of one or more optical signals is dropped from the optical ring. The optical ring is broken.

Some embodiments are methods of optical networking. At least one of: 1) adding one or more optical signals to an optically transparent optical ring, and 2) dropping one or more optical signals from the optically transparent optical ring is performed. Optical feedback in the optically transparent optical ring is substantially prevented.

Some embodiments are methods of optical networking. At least one of: 1) adding one or more optical signals to an optically transparent optical ring, and 2) dropping one or more optical signals from the optically transparent optical ring is performed. Coherent crosstalk in the optically transparent optical ring is substantially prevented.

In some embodiments, an add drop multiplexer is included in an optical node, an optical decoupling node, an optical anti-feedback node, and/or an optical anti-feedback node.

In some embodiments, at least two optical nodes and one or more optical fiber segments coupling the at least two optical nodes is included in the one or more optical nodes.

In some embodiments, at least two optical decoupling nodes, and one or more optical waveguides coupling the at least two optical decoupling nodes, is included in the one or more optical decoupling nodes. The one or more optical waveguides can include one or more optical fiber segments.

In some embodiments, at least two optical anti-feedback nodes, and one or more optical waveguides coupling the at least two optical anti-feedback nodes, is included in the one or more anti-feedback optical nodes. The one or more optical waveguides can include one or more optical fiber segments.

In some embodiments, at least two optical anti-crosstalk nodes, and one or more optical waveguides coupling the at least two optical anti-crosstalk nodes, is included in the one or more anti-crosstalk optical nodes. The one or more optical waveguides can include one or more optical fiber segments.

In some embodiments, at least one node of the one or more optical nodes, one or more optical decoupling nodes, one or more optical anti-feedback nodes, and/or one or more optical anti-crosstalk nodes includes a wavelength add, a wavelength drop, and at least two optical ports. The first optical port is at least optically coupled to the wavelength add. The second optical port is at least optically coupled to the wavelength drop. In multiple embodiments, at least four optical ports may be included. The third optical port is at least optically coupled to the wavelength add. The fourth optical port is at least optically coupled to the wavelength drop. In several embodiments, the third optical port and the fourth optical port are at least optically coupled with at least an optical waveguide. The optical waveguide can include one or more optical fiber segments.

In some embodiments, each optical decoupling node, each optical anti-feedback node, and/or each optical anti-crosstalk node, is associated with a logical ring of the optical network.

In some embodiments, the optical network is adapted to carry out protection switching.

In some embodiments, optical feedback in the optical network is prevented by breaking an optical ring. In some embodiments, coherent crosstalk in the optical network is prevented by breaking an optical ring. The optical ring includes the first optical fiber segment, the second optical fiber segment, and the plurality of one or more optical nodes. The optical ring can be broken at least somewhere between the first end of the first optical fiber segment and the first end of the second optical fiber segment.

In some embodiments, the wavelength add includes a directional coupler. In some embodiments, the wavelength drop includes a drop filter.

In some embodiments, the one or more housings at least substantially further enclose a third optical port at least optically coupled to the wavelength add and a fourth optical port at least optically coupled to the wavelength drop.

In some embodiments, a wavelength add adds a single wavelength and/or a wavelength drop drops a single wavelength. In other embodiments, a wavelength add adds multiple wavelengths and/or a wavelength drop drops multiple wavelengths.

Some embodiments employ protection switching responsive to a communication impairment, for example a fiber break.

In some embodiments, available bandwidth of the optical network is increased by adding one or more nodes to the plurality of one or more nodes. In some embodiments, the plurality of one or more nodes and the added nodes are located together. This may not disrupt traffic in the optical network in some embodiments. Manual modification of the plurality of one or more optical nodes may be unnecessary to increasing the available bandwidth.

Some embodiments practice at least in part technology disclosed in “Optical Networks” by Ramaswami, “Fiber-Optic Communication Systems” by Agrawal, “Erbium-Doped Fiber Amplifiers” by Becker, and/or “Scaling Limitations in Transparent Optical Networks Due to Low-Level Crosstalk” by Goldstein in IEEE Photonics Technology Letters of January 1995, all incorporated herein by reference.

### BRIEF DESCRIPTION OF THE FIGURES

FIG. 1 shows an embodiment of an optical network.

FIG. 2 shows an embodiment of open intercepts.

FIG. 3 shows an embodiment of closed intercepts.

FIG. 4 shows a further embodiment of a closed intercept.

FIG. 5 shows yet another embodiment of a closed intercept.

FIG. 6 shows an embodiment of an open intercept.

FIG. 7 shows a further embodiment of an open intercept.

FIG. 8 shows another embodiment of a closed intercept that adapts an open intercept.

FIG. 9 shows an embodiment of a wavelength add.

FIG. 10 shows an embodiment of a wavelength drop.

FIGS. 11 and 12 show an embodiment of protection switching in response to a communication impairment.

### DETAILED DESCRIPTION OF THE INVENTION

FIG. 1 shows an embodiment of an optical network 100. The optical network 100 has two physical rings, a working ring 110 and a protection ring 120. Other embodiments can have one physical ring or more physical rings. The physical rings are “broken” by the open intercepts 130. The open intercepts 130 can prevent each physical ring from forming a toplogical loop. Open intercepts 130 can substantially prevent one or more optical wavelengths from optically traversing the open intercepts 130. For example, one or more wavelengths 142 travel into the open intercepts 130 on the working ring 110. One or more wavelengths 144 travel from the open intercepts 130 on the working ring 110. When one or more wavelengths 142 are compared with one or more wavelengths 144, no wavelengths have optically traversed the open intercepts 130. One or more wavelengths 142 and one or more wavelengths 144 may have no wavelengths in common. One or more wavelengths 142 and one or more wavelengths 144 may have one or more wavelengths in common, but which have undergone at least one optical-to-electrical-to-optical conversion in the process of traversing the open intercepts 130. In this case, the one or more wavelengths in common between one or more wavelengths 142 and one or more wavelengths 144 have not optically traversed the open intercepts 130, because of the intervening optical-to-electrical-to-optical conversion. One or more wavelengths 142 and one or more wavelengths 144 may have one or more wavelengths in common, but the optical signal or content carried by the one or more wavelengths in common may be totally different. For example, the one or more wavelengths in common of the one or more wavelengths 142 may be dropped by the open intercepts 130, and then the one or more wavelengths in common of the one or more wavelengths 144 may be added by the open intercepts 130. In this case as well, the one or more wavelengths in common between one or more wavelengths 142 and one or more wavelengths 144 have not optically traversed the open intercepts 130, because of the intervening drops and adds.

Open intercepts 130 can serve as optical decoupling nodes, optical anti-feedback nodes, and/or optical anti-crosstalk nodes. If there are two or more open intercepts 130, the open intercepts 130 include optical waveguides, for example optical fiber, coupling together the open intercepts 130. The open intercepts 130 are coupled by optical fiber to closed intercepts 150, which can be optical nodes. If there are two or more closed intercepts 150, the closed intercepts 150 include optical fiber coupling together the closed intercepts 150. Open intercepts 130 have the ability to support up to as many logical rings as the number of open intercepts 130, in each physical ring. There should be at least as many closed intercepts 150 as there are logical rings.

In one embodiment with the open intercepts 130 being serially connected, incremental and modular upgrades to open intercepts 130 can be accomplished to add available bandwidth to the optical network. One or more open intercepts can be added to, for example, the last of the open intercepts 130 having free ports, and which can be the last of the open intercepts 130 in the series of open intercepts 130. In some embodiments, such upgrades do not disturb traffic in the optical network.

FIG. 2 shows an embodiment of open intercepts 132 and 134. Also shown are optical fiber segments 136 leading, for example, to other open intercepts or to closed intercepts. The open intercepts 132 and 134 work with the protection ring 120 and the working ring 110 respectively. One embodiment of open intercepts 132 and 134 employs four port nodes.

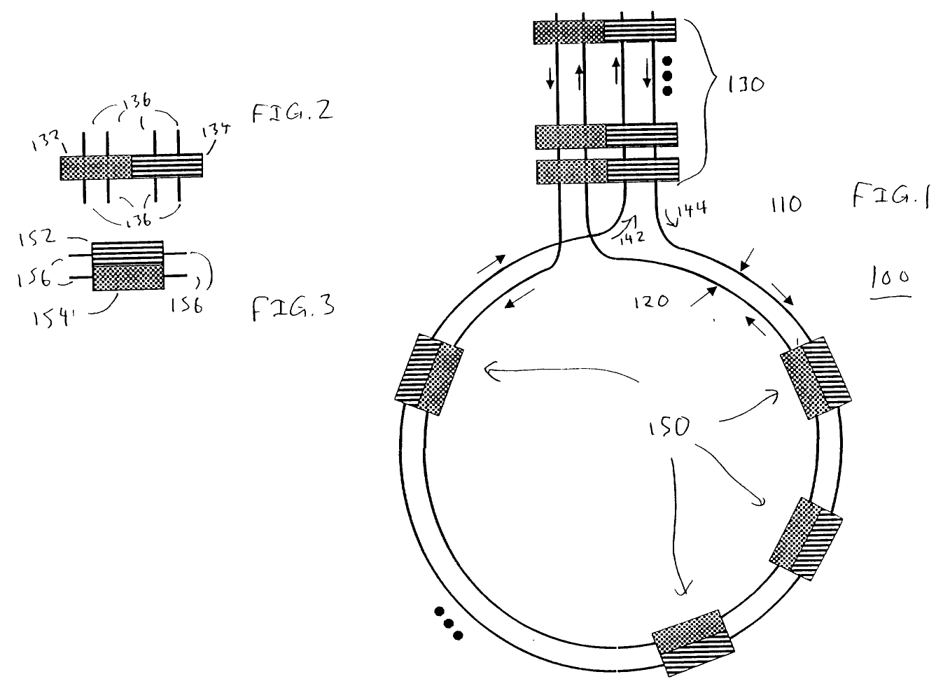

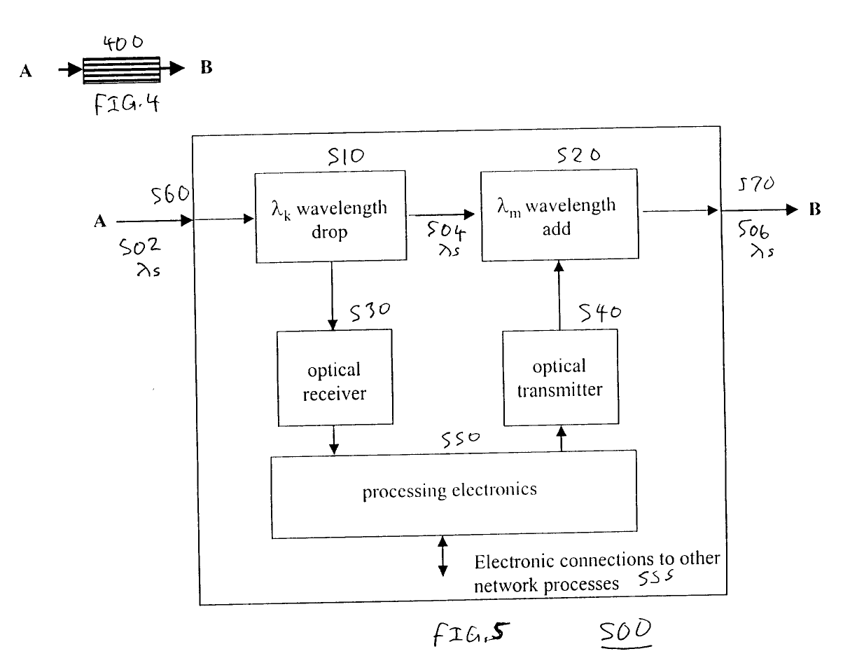

FIG. 3 shows an embodiment of closed intercepts 152 and 154. Also shown are optical fiber segments 156 leading, for example, to other closed intercepts or to open intercepts. The closed intercepts 152 and 154 work with the working ring 110 and the protection ring 120 respectively. One embodiment of closed intercepts 152 and 154 employs two port nodes.

FIG. 4 shows an embodiment of a closed intercept 400. Closed intercepts can include an optical add drop multiplexer.

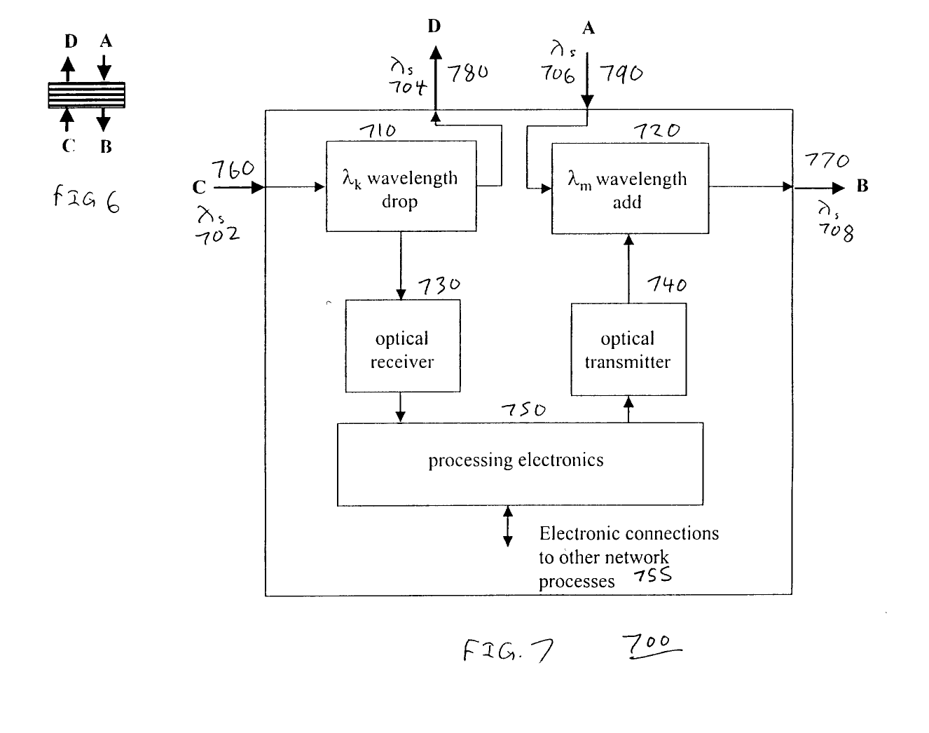

FIG. 5 shows an embodiment of a closed intercept 500. Closed intercept 500 includes a wavelength drop 510, a wavelength add 520, an optical receiver 530, an optical transmitter 540, processing electronics 550, and electronic connections to other network processes 555. Closed intercept 500 also includes Port A 560 and port B 570. Port A 560 receives one or more wavelengths 502. Wavelength drop 510 drops a wavelength from one or more wavelengths 502, producing one or more wavelengths 504. Wavelength add 520 adds a wavelength to one or more wavelengths 504, producing one or more wavelengths 506 for port B 570. The wavelength dropped by wavelength drop 510 goes to the optical receiver 530, and becomes processed by processing electronics 550. The wavelength added by wavelength add 520 come from the optical transmitter 540, and before that is processed by processing electronics 550, which communicates with electronic connections to other network processes 555. In other embodiments, the wavelength add 520 precedes the wavelength drop 510.

FIG. 6 shows an embodiment of an open intercept 600. Open intercepts 600 can include an optical add drop multiplexer.

FIG. 7 shows an embodiment of an open intercept 700. Open intercept 700 includes a wavelength drop 710, a wavelength add 720, an optical receiver 730, an optical transmitter 740, processing electronics 750, and electronic connections to other network processes 755. Open intercept 700 also includes Port A 790, port B 770, port C 760, and port D 780. Port C 760 receives one or more wavelengths 702. Wavelength drop 710 drops a wavelength from one or more wavelengths 702, producing one or more wavelengths 704 for port D 780. Wavelength add 720 adds a wavelength to one or more wavelengths 706 from port A 790, producing one or more wavelengths 708 for port B 770. The wavelength dropped by wavelength drop 710 goes to the optical receiver 730, and becomes processed by processing electronics 750. The wavelength added by wavelength add 720 come from the optical transmitter 740, and before that is processed by processing electronics 750, which communicates with electronic connections to other network processes 755.

FIG. 8 shows another embodiment of a closed intercept 800. Closed intercept 800 is similar to open intercept 700, and includes an optical waveguide 895, such as an optical fiber. The optical waveguide 895 couples port D 880 and port A 890. Closed intercept 800 includes a wavelength drop 810, a wavelength add 820, an optical receiver 830, an optical transmitter 840, processing electronics 850, and electronic connections to other network processes 855. Open intercept 800 also includes Port A 890, port B 870, port C 860, and port D 880. Port C 860 receives one or more wavelengths 802. Wavelength drop 710 drops a wavelength from one or more wavelengths 802, producing one or more wavelengths 805 for port D 880. Wavelength add 720 adds a wavelength to one or more wavelengths 805 from port A 890, producing one or more wavelengths 808 for port B 870. The wavelength dropped by wavelength drop 810 goes to the optical receiver 830, and becomes processed by processing electronics 850. The wavelength added by wavelength add 820 come from the optical transmitter 840, and before that is processed by processing electronics 850, which communicates with electronic connections to other network processes 855.

Thus, an embodiment with more ports than necessary can replace an embodiment with fewer ports.

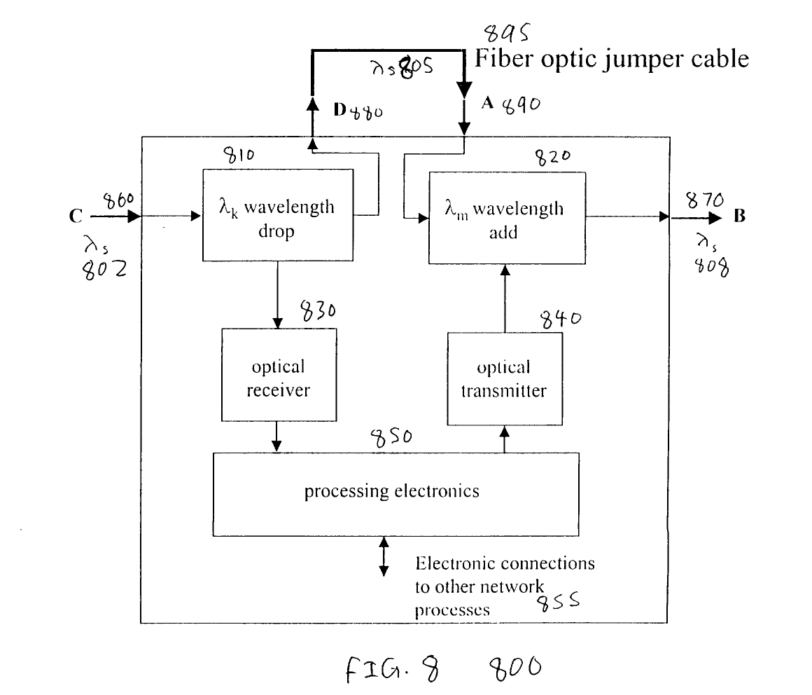

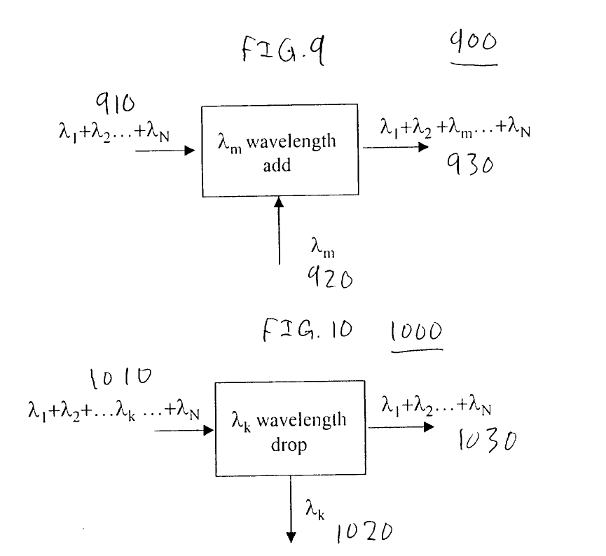

FIG. 9 shows an embodiment of a wavelength add 900. Wavelength add 900 receives one or more wavelengths 910, adds a wavelength 920, and produces one or more wavelengths 930. One or more wavelengths 930 include one or more wavelengths 910 and the wavelength 920. One embodiment of the wavelength add 900 adds only a wavelength to a stream of wavelengths.

Another embodiment of the wavelength add adds multiple wavelengths to a stream of wavelengths, along with corresponding multiple optical transmitters.

In some embodiments, multiple open intercepts, multiple closed intercepts, and/or one or more open intercepts and one or more closed intercepts can be in one housing, for example, where each intercept includes one or more parts of FIGS. 5, 7, and/or 8.

FIG. 10 shows an embodiment of a wavelength drop 1000. Wavelength drop 1000 receives one or more wavelengths 1010, drops a wavelength 1020, and produces one or more wavelengths 1030. One or more wavelengths 1030 include one or more wavelengths 1010 except for the wavelength 1020. One embodiment of the wavelength drop 900 drops only a wavelength from a stream of wavelengths.

Another embodiment of the wavelength drop drops multiple wavelengths from a stream of wavelengths, along with corresponding multiple optical receivers.

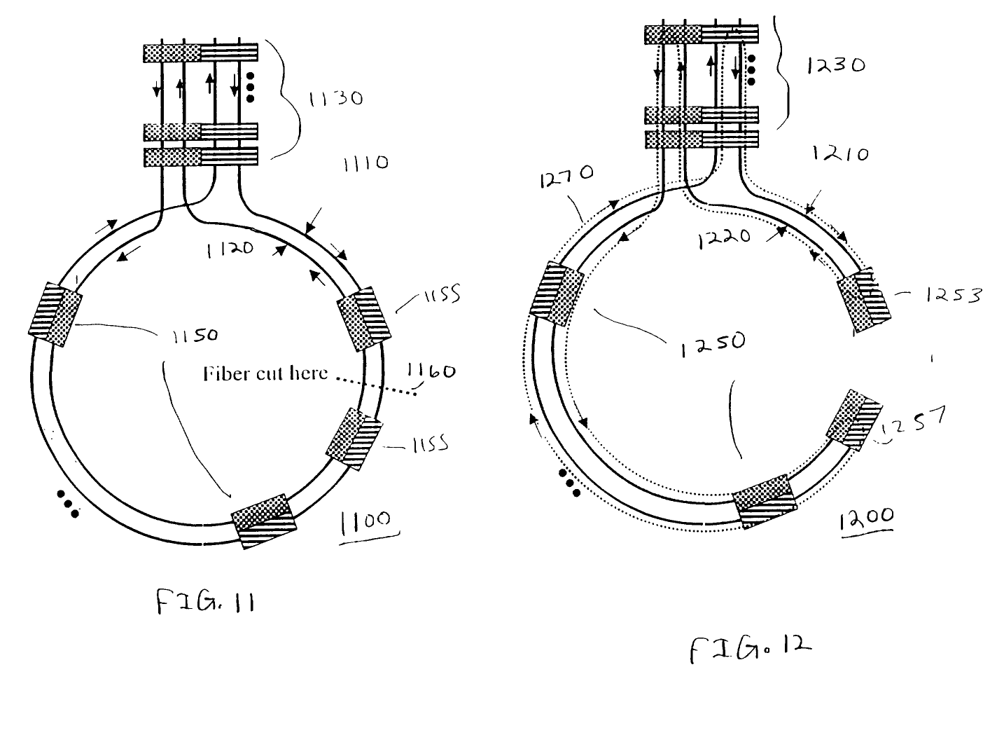

FIGS. 11 and 12 demonstrate an embodiment adapted to perform one method of protection switching in response to a communication impairment.

FIG. 11 shows an optical network 1100 with a working ring 1110, a protection ring 1120, open intercepts 1130, and closed intercepts 1150. A communication impairment occurs, for example a fiber cut 1160 between closed intercepts 1155. Prior to the fiber cut, two open loops exist, the working ring 1110 and the protection ring 1120. Both open loops are terminated by the open intercepts 1130.

FIG. 12 shows an embodiment of one response to a communication impairment. FIG. 12 shows an optical network 1200 with a working ring 1210, a protection ring 1220, open intercepts 1230, closed intercepts 1250, and closed intercepts by the fiber cut 1253 and 1257. Responsive to the communication impairment, protection switching occurs. The dashed line shows a data path 1270, such as for a new logical ring. After the fiber cut, one topological loop exists for the data path 1270, which may no longer be transparent. One end of the data path 1270 begins at the open intercepts 1230 of the working ring 1210, for example. The data path 1270 continues through the working ring 1210 until reaching one of the closed intercepts 1253 by the fiber cut on the working ring 1210. The data path 1270 moves from the closed intercept 1253 by the fiber cut on the working ring 1210 to the closed intercept 1253 by the fiber cut on the protection ring 1220, perhaps undergoing optical-to-electrical-to-optical conversions. The data path 1270 continues through the protection ring 1220 and loops through the open intercepts 1230 on the protection ring, perhaps undergoing optical-to-electrical-to-optical conversions. Then, the data path 1270 continues through the protection ring 1220 until reaching one of the closed intercepts 1257 by the fiber cut on the protection ring 1220. The data path 1270 moves from the closed intercept 1257 by the fiber cut on the protection ring 1220 to the closed intercept 1257 by the fiber cut on the working ring 1210, perhaps undergoing optical-to-electrical-to-optical conversions. The data path 1270 then ends with the open intercepts 1230 on the working ring 1210. This can be implemented, for example with standard SONET UPSR (unidirectional path switching ring) and others. In some embodiments, protection is enabled for single-fiber cuts.

When a claim or a claim limitation or part of a claim limitation “comprises A and B” or “includes A and B”, the claim or the claim limitation or the part of a claim limitation is open ended, allowing further inclusion of, for example, C, or C and D, etc.

1. An optical network, comprising:
a first optical fiber segment having a first end and a second end;
a second optical fiber segment having a first end and a second end;
a plurality of one or more optical nodes coupled to the second end of the first optical fiber segment and the second end of the second optical fiber segment; and
a plurality of one or more optical decoupling nodes coupled to the first end of the first optical fiber segment and the first end of the second optical fiber segment,
wherein the plurality of one or more optical nodes includes one or more optically transparent nodes being optically transparent for one or more optical wavelengths at least optically traversing the one or more optically transparent nodes, the one or more optically transparent nodes being optically transparent in at least one direction,
wherein one or more optical wavelengths carry traffic of the optical network, and
wherein the plurality of one or more optical decoupling nodes substantially prevents at least one of the one or more optical wavelengths from at least optically traversing the plurality of one or more optical decoupling nodes.

2. The network of claim 1, wherein each of the plurality of one or more optical nodes includes an add drop multiplexer.

3. The network of claim 1, wherein each of the plurality of one or more optical decoupling nodes includes an add drop multiplexer.

4. The apparatus of claim 1, wherein the plurality of one or more optical nodes includes at least two optical nodes, and the plurality of one or more optical nodes includes a plurality of one or more optical fiber segments coupling the at least two optical nodes.

5. The network of claim 1, wherein the plurality of one or more optical decoupling nodes includes at least two optical decoupling nodes, and the plurality of one or more optical decoupling nodes includes a plurality of one or more optical waveguides coupling the at least two optical decoupling nodes.

6. The network of claim 5, wherein the plurality of one or more optical waveguides includes one or more optical fiber segments.

7. The network of claim 1, wherein at least one node of the plurality of one or more optical decoupling nodes includes:
a wavelength add;
a wavelength drop;
a first optical port at least optically coupled to the wavelength add; and
a second optical port at least optically coupled to the wavelength drop.

8. The network of claim 7, wherein the wavelength add adds a single wavelength.

9. The network of claim 7, wherein the wavelength drop drops a single wavelength.

10. The network of claim 7, wherein the wavelength add adds multiple wavelengths.

11. The network of claim 7, wherein the wavelength drop drops multiple wavelengths.

12. The network of claim 7, wherein at least one node of the plurality of one or more optical decoupling nodes further includes:
a third optical port at least optically coupled to the wavelength add; and
a fourth optical port at least optically coupled to the wavelength drop.

13. The network of claim 1, wherein at least one node of the plurality of one or more optical nodes includes:
a wavelength add;
a wavelength drop;
a first optical port at least optically coupled to the wavelength add; and
a second optical port at least optically coupled to the wavelength drop.

14. The network of claim 13, wherein the wavelength add adds a single wavelength.

15. The network of claim 13, wherein the wavelength drop drops a single wavelength.

16. The network of claim 13, wherein the wavelength add adds multiple wavelengths.

17. The network of claim 13, wherein the wavelength drop drops multiple wavelengths.

18. The network of claim 13, wherein at least one node of the plurality of one or more optical nodes further includes:
a third optical port at least optically coupled to the wavelength add; and
a fourth optical port at least optically coupled to the wavelength drop.

19. The network of claim 18, wherein the third optical port and the fourth optical port are at least optically coupled with at least an optical waveguide.

20. The network of claim 19, wherein the optical waveguide includes one or more optical fiber segments.

21. The network of claim 1, wherein each node of the plurality of one or more optical decoupling nodes is associated with a logical ring of the optical network.

22. The network of claim 1, wherein the optical network is adapted to carry out protection switching.

23. The network of claim 1, wherein available bandwidth of the optical network is increased by adding one or more optical decoupling nodes to the plurality of one or more optical decoupling nodes.

24. The network of claim 23, wherein traffic in the optical network is not disrupted by adding one or more optical decoupling nodes to the plurality of one or more optical decoupling nodes.

25. The network of claim 23, wherein the plurality of one or more optical decoupling nodes and the added one or more optical decoupling nodes are located together.

26. The network of claim 23, wherein manual modification of the plurality of one or more optical nodes is unnecessary to increasing the available bandwidth.

27. An optical network, comprising:
a first optical fiber segment having a first end and a second end;
a second optical fiber segment having a first end and a second end;
a plurality of one or more optical nodes coupled to the second end of the first optical fiber segment and the second end of the second optical fiber segment; and
a plurality of one or more optical anti-feedback nodes coupled to the first end of the first optical fiber segment and the first end of the second optical fiber segment, wherein the plurality of one or more optical anti-feedback nodes substantially prevents optical feedback in the optical network,
wherein the plurality of one or more optical nodes includes one or more optically transparent nodes being optically transparent for one or more optical wavelengths at least optically traversing the one or more optically transparent nodes, the one or more optically transparent nodes being optically transparent in at least one direction.

28. The network of claim 27, wherein each of the plurality of one or more optical nodes includes an add drop multiplexer.

29. The network of claim 27, wherein each of the plurality of one or more optical anti-feedback nodes includes an add drop multiplexer.

30. The network of claim 27, wherein the plurality of one or more optical nodes includes at least two optical nodes, and the plurality of one or more optical nodes includes a plurality of one or more optical fiber segments coupling the at least two optical nodes.

31. The network of claim 27, wherein the plurality of one or more optical anti-feedback nodes includes at least two optical anti-feedback nodes, and the plurality of one or more optical anti-feedback nodes includes a plurality of one or more optical waveguides coupling the at least two optical anti-feedback nodes.

32. The network of claim 31, wherein the plurality of one or more optical waveguides includes one or more optical fiber segments.

33. The network of claim 27, wherein at least one node of the plurality of one or more optical anti-feedback nodes prevents optical feedback in the optical network by breaking an optical ring, the optical ring including the first optical fiber segment, the second optical fiber segment, and the plurality of one or more optical nodes.

34. The network of claim 33, wherein at least one node of the plurality of one or more optical anti-feedback nodes breaks the optical ring at the optical node at least between the first end of the first optical fiber segment and the first end of the second optical fiber segment.

35. The network of claim 27, wherein at least one node of the plurality of one or more optical anti-feedback nodes includes:
a wavelength add;
a wavelength drop;
a first optical port at least optically coupled to the wavelength add; and
a second optical port at least optically coupled to the wavelength drop.

36. The network of claim 35, wherein the wavelength add adds a single wavelength.

37. The network of claim 35, wherein the wavelength drop drops a single wavelength.

38. The network of claim 35, wherein the wavelength add adds multiple wavelengths.

39. The network of claim 35, wherein the wavelength drop drops multiple wavelengths.

40. The network of claim 35, wherein at least one node of the plurality of one or more optical anti-feedback nodes further includes:
a third optical port at least optically coupled to the wavelength add; and
a fourth optical port at least optically coupled to the wavelength drop.

41. The network of claim 27, wherein at least one node of the plurality of one or more optical nodes includes:
a wavelength add;
a wavelength drop;
a first optical port at least optically coupled to the wavelength add; and
a second optical port at least optically coupled to the wavelength drop.

42. The network of claim 41, wherein the wavelength add adds a single wavelength.

43. The network of claim 41, wherein the wavelength drop drops a single wavelength.

44. The network of claim 41, wherein the wavelength add adds multiple wavelengths.

45. The network of claim 41, wherein the wavelength drop drops multiple wavelengths.

46. The network of claim 41, wherein at least one node of the plurality of one or more optical nodes further includes:
a third optical port at least optically coupled to the wavelength add; and
a fourth optical port at least optically coupled to the wavelength drop.

47. The network of claim 46, wherein the third optical port and the fourth optical port are at least optically coupled with at least an optical waveguide.

48. The network of claim 47, wherein the optical waveguide includes one or more optical fiber segments.

49. The network of claim 27, wherein each node of the plurality of one or more optical anti-feedback nodes is associated with a logical ring of the optical network.

50. The network of claim 27, wherein the optical network is adapted to carry out protection switching.

51. The network of claim 27, wherein available bandwidth of the optical network is increased by adding one or more optical anti-feedback nodes to the plurality of one or more optical anti-feedback nodes.

52. The network of claim 51, wherein traffic in the optical network is not disrupted by adding one or more optical anti-feedback nodes to the plurality of one or more optical anti-feedback nodes.

53. The network of claim 51, wherein the plurality of one or more optical anti-feedback nodes and the added one or more optical anti-feedback nodes are located together.

54. The network of claim 51, wherein manual modification of the plurality of one or more optical nodes is unnecessary to increasing the available bandwidth.

55. An optical network, comprising:
a first optical fiber segment having a first end and a second end;
a second optical fiber segment having a first end and a second end;
a plurality of one or more optical nodes coupled to the second end of the first optical fiber segment and the second end of the second optical fiber segment; and
a plurality of one or more optical anti-crosstalk nodes coupled to the first end of the first optical fiber segment and the first end of the second optical fiber segment, wherein the plurality of one or more optical anti-crosstalk nodes substantially prevents coherent crosstalk in the optical network,
wherein the plurality of one or more optical nodes includes one or more optically transparent nodes being optically transparent for one or more optical wavelengths at least optically traversing the one or more optically transparent nodes, the one or more optically transparent nodes being optically transparent in at least one direction.

56. The network of claim 55, wherein each of the plurality of one or more optical nodes includes an add drop multiplexer.

57. The network of claim 55, wherein each of the plurality of one or more optical anti-feedback nodes includes an add drop multiplexer.

58. The network of claim 55, wherein the plurality of one or more optical nodes includes at least two optical nodes, and the plurality of one or more optical nodes includes a plurality of one or more optical fiber segments coupling the at least two optical nodes.

59. The network of claim 55, wherein the plurality of one or more optical anti-crosstalk nodes includes at least two optical anti-crosstalk nodes, and the plurality of one or more optical anti-feedback nodes includes a plurality of one or more optical waveguides coupling the at least two optical anti-crosstalk nodes.

60. The network of claim 59, wherein the plurality of one or more optical waveguides includes one or more optical fiber segments.

61. The network of claim 55, wherein at least one node of the plurality of one or more optical anti-crosstalk nodes prevents coherent crosstalk in the optical network by breaking an optical ring, the optical ring including the first optical fiber segment, the second optical fiber segment, and the plurality of one or more optical nodes.

62. The network of claim 61, wherein at least one node of the plurality of one or more optical anti-crosstalk nodes breaks the optical ring at the optical node at least between the first end of the first optical fiber segment and the first end of the second optical fiber segment.

63. The network of claim 55, wherein at least one node of the plurality of one or more optical anti-crosstalk nodes includes:
a wavelength add;
a wavelength drop;
a first optical port at least optically coupled to the wavelength add; and
a second optical port at least optically coupled to the wavelength drop.

64. The network of claim 63, wherein the wavelength add adds a single wavelength.

65. The network of claim 63, wherein the wavelength drop drops a single wavelength.

66. The network of claim 63, wherein the wavelength add adds multiple wavelengths.

67. The network of claim 63, wherein the wavelength drop drops multiple wavelengths.

68. The network of claim 63, wherein at least one node of the plurality of one or more optical anti-crosstalk nodes further includes:
a third optical port at least optically coupled to the wavelength add; and
a fourth optical port at least optically coupled to the wavelength drop.

69. The network of claim 55, wherein at least one node of the plurality of one or more optical nodes includes:
a wavelength add;
a wavelength drop;
a first optical port at least optically coupled to the wavelength add; and
a second optical port at least optically coupled to the wavelength drop.

70. The network of claim 69, wherein the wavelength add adds a single wavelength.

71. The network of claim 69, wherein the wavelength drop drops a single wavelength.

72. The network of claim 69, wherein the wavelength add adds multiple wavelengths.

73. The network of claim 69, wherein the wavelength drop drops multiple wavelengths.

74. The network of claim 69, wherein at least one node of the plurality of one or more optical nodes further includes:
a third optical port at least optically coupled to the wavelength add; and
a fourth optical port at least optically coupled to the wavelength drop.

75. The network of claim 74, wherein the third optical port and the fourth optical port are at least optically coupled with at least an optical waveguide.

76. The network of claim 75, wherein the optical waveguide includes one or more optical fiber segments.

77. The network of claim 55, wherein each node of the plurality of one or more optical anti-crosstalk nodes is associated with a logical ring of the optical network.

78. The network of claim 55, wherein the optical network is adapted to carry out protection switching.

79. The network of claim 55, wherein available bandwidth of the optical network is increased by adding one or more optical anti-crosstalk nodes to the plurality of one or more optical anti-crosstalk nodes.

80. The network of claim 79, wherein traffic in the optical network is not disrupted by adding one or more optical anti-crosstalk nodes to the plurality of one or more optical anti-crosstalk nodes.

81. The network of claim 79, wherein the plurality of one or more optical anti-crosstalk nodes and the added one or more optical anti-crosstalk nodes are located together.

82. The network of claim 79, wherein manual modification of the plurality of one or more optical nodes is unnecessary to increasing the available bandwidth.

83. An optical node, comprising:
one or more housings at least substantially enclosing:
a wavelength add;
a wavelength drop;
a first optical port adapted to at least optically couple to a first node of a plurality of one or more optical nodes, the first optical port at least optically coupled to the wavelength add; and
a second optical port adapted to at least optically couple to a second node of the plurality of one or more optical nodes, the second optical port at least optically coupled to the wavelength drop, and the plurality of one or more optical nodes includes one or more optically transparent nodes being optically transparent for one or more optical wavelengths at least optically traversing the one or more optically transparent nodes, the one or more optically transparent nodes being optically transparent in at least one direction,
wherein the first optical port and the second optical port remain at least optically substantially decoupled within the optical node at one or more optical wavelengths that carry traffic in at least part of the plurality of one or more optical nodes.

84. The node of claim 83, wherein the wavelength add includes a directional coupler.

85. The node of claim 83, wherein the wavelength drop includes a drop filter.

86. The node of claim 83, wherein the wavelength add adds a single wavelength.

87. The node of claim 83, wherein the wavelength drop drops a single wavelength.

88. The node of claim 83, wherein the wavelength add adds multiple wavelengths.

89. The node of claim 83, wherein the wavelength drop drops multiple wavelengths.

90. The node of claim 83, wherein the one or more housings at least substantially further encloses:
a third optical port at least optically coupled to the wavelength add; and
a fourth optical port at least optically coupled to the wavelength drop.

91. An optical node, comprising:
one or more housings at least substantially enclosing:
a wavelength add;
a wavelength drop;
a first optical port adapted to at least optically couple to a first node of a plurality of one or more optical nodes, the first optical port at least optically coupled to the wavelength add; and
a second optical port adapted to at least optically couple to a second node of the plurality of one or more optical nodes, the second optical port at least optically coupled to the wavelength drop, and the plurality of one or more optical nodes includes one or more optically transparent nodes being optically transparent for one or more optical wavelengths at least optically traversing the one or more optically transparent nodes, the one or more optically transparent nodes being optically transparent in at least one direction,
wherein the optical node substantially prevents optical feedback in the plurality of one or more optical nodes.

92. The node of claim 91, wherein the wavelength add includes a directional coupler.

93. The node of claim 91, wherein the wavelength drop includes a drop filter.

94. The node of claim 91, wherein the wavelength add adds a single wavelength.

95. The node of claim 91, wherein the wavelength drop drops a single wavelength.

96. The node of claim 91, wherein the wavelength add adds multiple wavelengths.

97. The node of claim 91, wherein the wavelength drop drops multiple wavelengths.

98. The node of claim 91, wherein the one or more housings at least substantially further encloses:
a third optical port at least optically coupled to the wavelength add; and
a fourth optical port at least optically coupled to the wavelength drop.

99. An optical node, comprising:
one or more housings at least substantially enclosing:
a wavelength add;
a wavelength drop;
a first optical port adapted to at least optically couple to a first node of a plurality of one or more optical nodes, the first optical port at least optically coupled to the wavelength add; and
a second optical port adapted to at least optically couple to a second node of the plurality of one or more optical nodes, the second optical port at least optically coupled to the wavelength drop, and the plurality of one or more optical nodes includes one or more optically transparent nodes being optically transparent for one or more optical wavelengths at least optically traversing the one or more optically transparent nodes, the one or more optically transparent nodes being optically transparent in at least one direction, wherein the optical node substantially prevents coherent crosstalk in the plurality of one or more optical nodes.

100. The node of claim 99, wherein the wavelength add includes a directional coupler.

101. The node of claim 99, wherein the wavelength drop includes a drop filter.

102. The node of claim 99, wherein the wavelength add adds a single wavelength.

103. The node of claim 99, wherein the wavelength drop drops a single wavelength.

104. The node of claim 99, wherein the wavelength add adds multiple wavelengths.

105. The node of claim 99, wherein the wavelength drop drops multiple wavelengths.

106. The node of claim 99, wherein the one or more housings at least substantially further encloses:
a third optical port at least optically coupled to the wavelength add; and
a fourth optical port at least optically coupled to the wavelength drop.

107. A method of optical networking, comprising:
adding a first plurality of one or more optical signals to an optically transparent optical ring carrying wavelength division multiplexed signals;
dropping a second plurality of one or more optical signals from the optically transparent optical ring; and
breaking the optically transparent optical ring.

108. The method of claim 107, further comprising:
responsive to communication impairment, protection switching.

109. The method of claim 108, wherein the communication impairment includes a fiber break.

110. The method of claim 107, further comprising:
adding available bandwidth to the optically transparent optical ring without disrupting traffic in already present bandwidth in the optically transparent optical ring.

111. A method of optical networking, comprising:
performing at least one of: 1) adding one or more optical signals to an optically transparent optical ring, and 2) dropping one or more optical signals from the optically transparent optical ring; and
substantially preventing optical feedback in the optically transparent optical ring.

112. The method of claim 111, further comprising:
responsive to communication impairment, protection switching.

113. The method of claim 112, wherein the communication impairment includes a fiber break.

114. The method of claim 111, further comprising:
adding available bandwidth to the optically transparent optical ring without disrupting traffic in already present bandwidth in the optically transparent optical ring.

115. A method of optical networking, comprising:
performing at least one of:
1) adding one or more optical signals to an optically transparent optical ring, and
2) dropping one or more optical signals from the optically transparent optical ring; and
substantially preventing coherent crosstalk in the optically transparent optical ring.

116. The method of claim 115, further comprising:
responsive to communication impairment, protection switching.

117. The method of claim 116, wherein the communication impairment includes a fiber break.

118. The method of claim 115, further comprising:
adding available bandwidth to the optically transparent optical ring without disrupting traffic in already present bandwidth in the optically transparent optical ring.
